(19) United States
(12) Patent Application Publication
(10) Pub. No.: US 2007/0026093 A1
(43) Pub. Date: Feb. 1, 2007

(54) Apparatus and method for energy recovery from a spinning device

(76) Inventor: Keven Coates, Cypress, TX (US)

Correspondence Address: TEXAS INSTRUMENTS INCORPORATED, P O BOX 655474, M/S 3999, DALLAS, TX, 75265, US

(21) Appl. No.: 11/189,317

(22) Filed: Jul. 26, 2005

(51) Int. Cl. B29C 47/00

(52) U.S. Cl. 425/97

(57) ABSTRACT

An apparatus and method in a portable electronic device for slowing down a spinning device to provide power to a system or charge a battery. The apparatus includes a spinning device coupled to a boost device and at least one switch. The boost device may boost a voltage generated by slowing down the spinning device to power a system or charge a battery. The apparatus and method may decrease the demand on the battery of a portable device and may lengthen the time that the portable device may operate independent of an outside power source.

### TECHNICAL FIELD OF THE INVENTION

The present invention generally relates to energy produced by a spinning device. More particularly, the present invention relates to recovering the energy produced by slowing down the spinning device. Still more particularly, the invention relates to recovering energy produced by slowing down the spinning device to provide power to an electronic device or to charge a battery.

### BACKGROUND OF THE INVENTION

Battery life is the amount of time a battery will provide power to an electronic device. Battery life limits the time that users may operate portable electronic devices such as computers, compact disk (CD) players, and music devices without a connection to an outside power source, such as a wall outlet or a generator. A long battery life is desirable for portable electronic devices. For example, a user may prefer a portable laptop computer that may have a four-hour battery life over a similar portable laptop computer that may only have a three-hour battery life.

One way to lengthen battery life in a portable electronic device is by reducing wasted power in the device. Within portable electronic devices, power is often wasted by spinning devices. One spinning device that may be present in portable electronic devices is a cooling fan. The cooling fan includes a motor that spins a fan blade at a high speed to cool the components in the portable electronic device. The motor rotates a spindle or a rotor that spins the fan blade. When power is removed from the spinning motor, the motor gradually spins to a stop and generates energy in the form of a voltage over the windings of the motor. The voltage may be called a back EMF (electromotive force) voltage as described in more detail below. The level of voltage generated may depend on various properties of the fan blade. For example, the greater the speed of the fan blade when power is removed from the motor, the more back EMF voltage will be generated.

Another type of spinning device present in electronic devices is a spinning media device. Spinning media devices are commonly used to store and retrieve information and are found in the form of hard drives, CD players, digital video disk (DVD) players, and tape systems. In a spinning media device, a motor spins a media disk or tape at a high speed so that data may be magnetically read or written to the media disk or tape by a read-write head. This may be described as a read or a write. The media disk or tape may be a hard disk drive, a CD, a DVD, magnetic tape, or any other media storage device. The motor rotates a spindle or a rotor that spins the media disk or tape. When power is removed from the spinning motor, the motor gradually spins to a stop and generates a back EMF voltage over the windings of the motor. The level of generated voltage may depend on the various properties of the spinning media disk or tape. For example, the greater the speed of the spinning media disk or tape when power is removed from the motor, the more back EMF voltage will be generated.

In many spinning devices, the back EMF voltage generated may not be fully utilized. This back EMF voltage may be wasted as heat energy or may be used within a device only in cases of emergency shutdown. In portable electronic devices, the motor used for spinning the media device or cooling fan may be turned on and off many times during the course of operation. This may result in a significant amount of back EMF voltage generated by the motor being wasted every time the motor is turned off. Further, a significant amount of back EMF voltage may be wasted when multiple spinning devices are used in the portable electronic device.

For example, many laptop computers contain a hard disk drive and a CD player, both of which are spinning media devices and may contain motors capable of generating back EMF voltages. If the back EMF voltages generated by the hard disk drive and the CD player could be utilized, the battery life of the laptop computer may be extended. A device that may utilize the back EMF voltage generated by spinning devices within a portable electronic device so that the battery life in the portable electronic device may be extended would be beneficial.

### SUMMARY OF THE INVENTION

The problems noted above are solved by coupling at least one spinning device capable of producing a voltage to a boost device. The spinning device may be a compact disk (CD) device, a digital video disk (DVD) device, a hard disk drive, a tape system, or a cooling fan. A power source, such as a battery, electrical outlet, or uninterruptible power supply, couples to the spinning device and provides power to the spinning device. A voltage regulator couples between the power source and the spinning device. The voltage regulator also couples to a device electronics unit and regulates the voltage sent to the device electronics unit and the spinning device.

The device electronics unit includes a north bridge and a south bridge. The north bridge may couple to a processor, a memory device, a cache, a graphics controller, and/or a PCMCIA port. A display controller may couple to the graphics controller. The south bridge couples to a peripheral device, a compact disk (CD) device, a digital video disk (DVD) device, a hard disk drive, and/or an input output (I/O) controller. The I/O controller may couple to a floppy disk drive.

The boost device couples to both the voltage regulator and the spinning device. A first switch couples between the voltage regulator and the spinning device, and a second switch couples between the spinning device and the boost device. The first and second switches may be MOSFET switches. When the first switch closes, current may flow to the spinning device, and the spinning device may spin a rotating medium, such as a hard drive disk or cooling fan. When the second switch closes, current may flow from the spinning device to the boost device and further to the device electronics unit.

The spinning device includes a motor; the motor consists of a shaft attached to a frame. The shaft is further attached to a rotor capable of rotating at a variable spin rate. The rotating medium is attached to the rotor, and the rotor is capable of spinning the rotating medium. The rotating medium may, for example, be a disk such as a compact disk in a CD player. The motor within the CD player spins the compact disk so that data may be read from the compact disk. The motor may be a spindle motor, a stepper motor, a brushless DC motor, a servomotor, or a variable reluctance motor.

The motor may also include a plurality of poles attached to the frame with windings attached to each pole. As the rotor spins, a voltage generates across the windings. The voltage is proportional to the spin rate of the rotor. Once power to the motor has been removed, voltage may be generated across at least one winding of the motor. The voltage generated across the at least one winding may be boosted by the boost device. The at least one winding may couple to the voltage regulator and the boost device.

In one embodiment of the invention, the boost device may couple to the voltage regulator. When the spinning device generates voltage, the boost device may boost the generated voltage to power the device electronics unit. In another embodiment of the invention, the boost device couples to the battery through a diode. The cathode of the diode may couple to the battery, and the anode of the diode may couple to the boost device. When the spinning device generates voltage, the boost device may boost the generated voltage and charge the battery. The battery is charged if a voltage at the boost device is greater than a voltage drop at the diode plus a voltage of the battery. The diode prevents current flow from the battery to the boost device. In some embodiments of the invention, a charge controller couples to the battery and the diode. The charge controller prevents the boost device from overcharging the battery and may optimize charging of the battery. The battery powers the device electronics unit.

### BRIEF DESCRIPTION OF THE DRAWINGS

The embodiments of the invention will now be described with reference to the accompanying drawings in which:

FIG. 1 shows an overhead view of a motor unit, the motor unit comprising a rotor in operative association with a stator;

FIG. 2 shows a spinning device implemented in a portable electronic device;

FIG. 3 shows a graph of energy and current in the motor unit versus time;

FIG. 4A, in accordance with some embodiments of the invention, shows a system in which energy generated by the spinning device passes through a boost device to power a device electronics unit;

FIG. 4B, in accordance with some embodiments of the invention, shows a system in which energy generated by multiple spinning device electronics powers the device electronics unit;

FIG. 5A, in accordance with some embodiments of the invention, shows a system in which energy generated by the spinning device passes through the boost device to charge a battery;

FIG. 5B, in accordance with some embodiments of the invention, shows a system in which energy generated by multiple spinning device electronics charges the battery; and

FIG. 6 shows the system shown in FIG. 5A coupled to a portable computer system.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the terms “couple,” “couples,” or “coupling” are intended to mean either an indirect or direct electrical connection. Thus, if a first device couples to a second device, that connection may be through a direct electrical connection or though an indirect electrical connection via other devices and connections. Further, the term “attach” or “attaches” is intended to mean either an indirect or direct physical connection. Thus, if a first component is attached to a second component, that connection may be through a direct physical connection or through an indirect physical connection via other components and connections.

### DETAILED DESCRIPTION OF EMBODIMENTS

In accordance with some embodiments of the invention, a power source is coupled to a spinning device. When power is removed from the spinning device, the spinning device produces a voltage. A boost device coupled to the spinning device boosts this voltage and provides power to a device electronics unit or charges a battery.

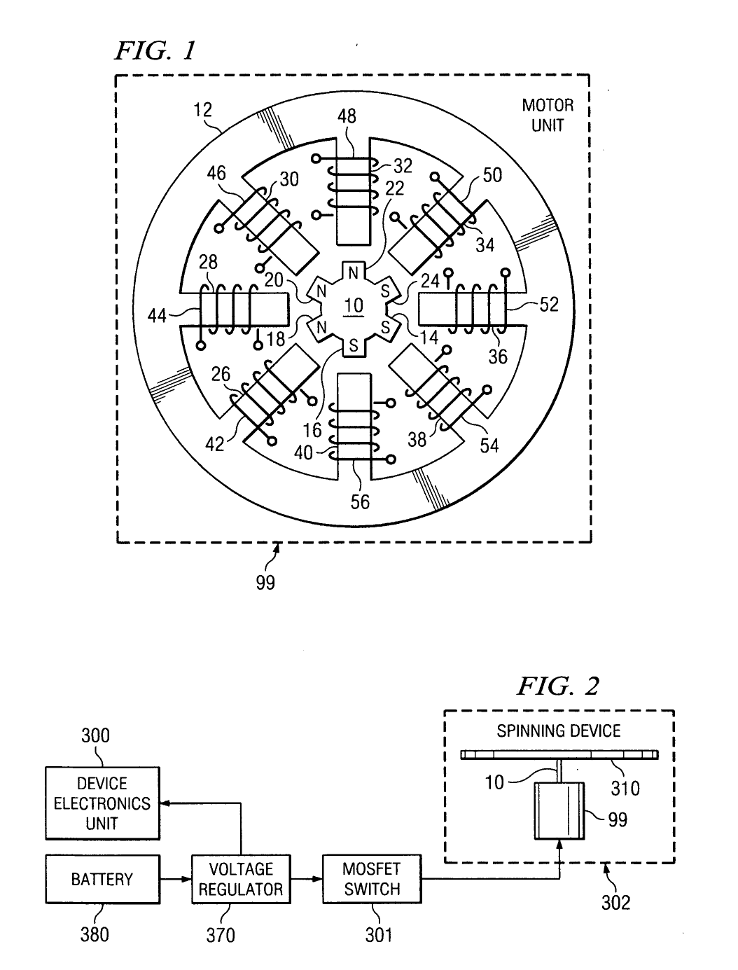

Referring to FIG. 1, a motor unit 99 is shown as an example with the understanding that the following explanation is applicable to stepping motors of permanent-magnet and variable-reluctance types as well as other types of motors that may also be implemented in a cooling fan, hard disk drive, or other type of spinning device. Motor unit 99 includes a rotor 10 in operative association with a stator 12. Rotor 10 attaches to a shaft (not shown) attached to stator 12. Rotor 10 has a plurality of teeth 14, 16, 18, 20, 22, and 24 which may be magnets that have a fixed north or south polarity. Stator 12 has a plurality of poles 26, 28, 30, 32, 34, 36, 38, and 40. On these poles are respective windings 42, 44, 46, 48, 50, 52, 54, and 56. Current flowing through the windings of a pole may make the polarity of the pole north or south. Furthermore, as the direction of current flowing through an individual winding changes, the polarity of the corresponding pole may also change from north to south and vice versa.

Magnets are attracted to other magnets with opposite polarities. Magnets with the same polarity repel each other. For example, tooth 22 may have a permanent south polarity. When pole 32 is of north polarity, tooth 22 is attracted to pole 32. When current in coil 48 is reversed, thereby changing the polarity of pole 32 from north to south polarity, tooth 22 is repelled from pole 32, thus causing tooth 22 to move away from pole 32. The teeth and poles shown in motor unit 99 may behave in a similar fashion and, when operated in a coordinated manner, may thus rotate rotor 10.

Referring to FIG. 2, a spinning device 302 in a portable electronic device may be coupled to a MOSFET switch 301 capable of switching at high speeds. MOSFET switch 301 is a transistor that may be in an open state or a closed state when appropriate voltages are applied to its gate region (not shown). MOSFET switch 301 in the open state prevents the flow of electricity to spinning device 302. MOSFET switch 301 in the closed state allows electricity to flow to spinning device 302. In some embodiments of the invention, MOSFET switch 301 may be controlled so that the switch is in the open state or closed state by a device electronics unit 300. MOSFET switch 301 may further couple to a voltage regulator 370. Voltage regulator 370 may couple to a battery 380 and device electronics unit 300.

Spinning device 302 may comprise a disk 310, a rotor 10, and motor unit 99. Spinning device 302 may be found in a hard disk drive in a laptop computer, a portable CD player, a mobile (DVD) player, a hard drive of a portable music player, a cooling fan, or in any system that implements a spinning device. Motor unit 99 may be a spindle motor, a stepper motor, a brushless DC motor, a variable reluctance motor, a servomotor, or any type of motor that may be used to spin disk 310. Motor unit 99 may function as described above. Disk 310 may be a CD, a DVD, a hard drive disk, or any disk device on which data may be read and/or written.

Device electronics unit 300 may include a memory device, a processor, a graphics controller, a cache, a display, a PCMCIA port, an audio output device, a peripheral device, an I/O controller, a floppy drive, a keyboard, a hard drive, a mouse, a DVD player, a CD player, or any type of electrical device. Voltage regulator 370 is any device that takes in an input voltage that may vary and outputs a constant voltage. Voltage regulator 370 may comprise, for example, a Texas Instruments UA78M10 Fixed Positive Voltage Regulator or any other device capable of regulating the voltage output from battery 380 to both device electronics unit 300 and spinning device 302. Thus, battery 380 powers components of device electronics unit 300 as well as spinning device 302.

When MOSFET switch 301 is in the open state, spinning device 302 is inactive and current does not flow from battery 380 to device electronics unit 300. MOSFET switch 301 in the open state ensures that current is not sent to spinning device 302. Current flows to motor unit 99 when MOSFET switch 301 is closed. For example, when data needs to be read from disk 310, battery 380 sends current through voltage regulator 370 and MOSFET switch 301 that is in the closed state to motor unit 99. Motor unit 99 may spin rotor 10 and disk 310 so that data may be read from disk 310. Once the read is complete and motor unit 99 is inactive, MOSFET switch 301 may be placed into the open state so that current does not flow from battery 380 to motor unit 99. Battery 380 may send current to device electronics unit 300 and spinning device 302 at the same time.

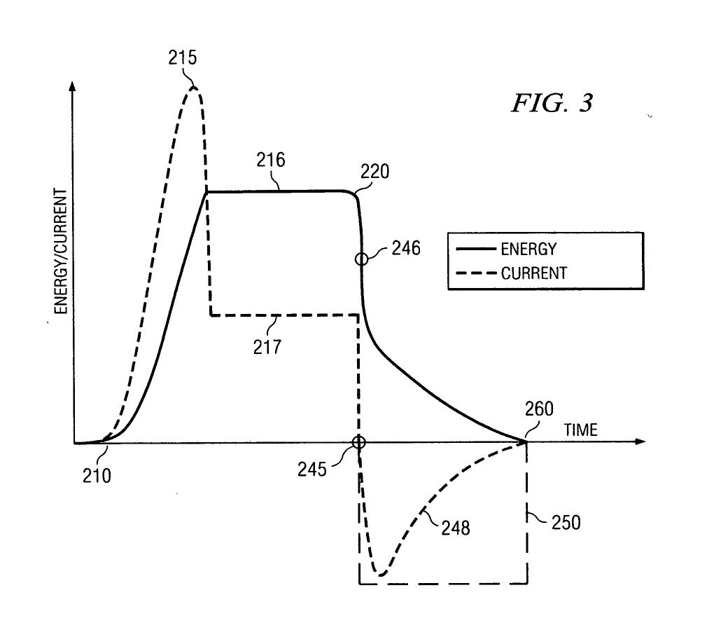

Turning now to FIG. 3, energy and current flowing through motor unit 99 as a function of time is shown for the system of FIG. 2. The energy of motor unit 99 and the current flowing through motor unit 99 are displayed on the vertical axis, and time is displayed on the horizontal axis. Energy is illustrated on the graph as a solid line, while current is illustrated as a dotted line. Operation of the system shown in FIG. 2 may be used to explain the graph of FIG. 3. In some embodiments of the invention as shown in FIG. 2, spinning device 302 may be part of a portable CD player. When a user turns on the portable CD player 210, MOSFET switch 301 may be in the closed state and current may flow from battery 380 through voltage regulator 370 and further through closed MOSFET switch 301 to motor unit 99. A current spike 215 may occur when motor unit 99 turns on. Current spike 215 may occur to start the rotation of the stationary spinning device 302 and bring the spinning device to a steady rotation speed. The spinning device reaching a steady rotation speed is shown in FIG. 3 as the energy of motor unit 99 at steady state 216 after current spike 215. Thus, as described above, current flowing through motor unit 99 from battery 380 produces physical energy in the form of the rotation of rotor 10.

Current reaches a steady state 217 after motor unit 99 reaches a steady state 216 of energy. It may be seen that the steady state current 216 is significantly less than the level of current in the initial current spike 215. The steady states for both energy 216 and current 217 occur after motor unit 99 is rotating at a constant speed. In the CD player example above, steady states of energy 216 and current 217 may be seen when the CD player is reading a CD. When the user decides to stop playing the CD, the user may turn off the CD player. At point 220, as shown in FIG. 3, current is no longer flowing 245 to motor unit 99. Thus, the energy of motor unit 99 begins to decay 246.

However, some energy is still present 246 in motor unit 99 because rotor 10 may still be rotating. Angular momentum is the measure of the tendency of a rotating body to continue rotating and may be further defined as the product of a body's mass, velocity, and distance from the axis of rotation. The angular momentum of spinning disk 310 allows spinning disk 310 and corresponding rotor 10 to continue spinning even after current is no longer flowing to motor unit 99. When current no longer flows 245 into motor unit 99 and rotor 10 is still rotating, spinning device 302 may become a generator and may generate a back EMF voltage and a corresponding current 248 out of motor unit 99.

More specifically, referring back to FIG. 1, when current no longer flows into motor unit 99, a magnetic field created by the teeth of rotor 10 generates a back EMF voltage and induces current in the windings of stator 12 as rotor 10 continues to rotate. Thus, spinning device 302 generates power (power (P)=voltage (V)* current (I)). Motor unit 99 generates power 250 until rotor 10 stops spinning 260. At this time there is no more energy or current flowing through motor unit 99.

In the system shown in FIG. 2, the back EMF voltage and current created by spinning device 302 may be dissipated as heat or may be stored within a capacitor for use in a situation such as an emergency shutdown. However, these solutions do not take advantage of the energy generated by spinning device 302.

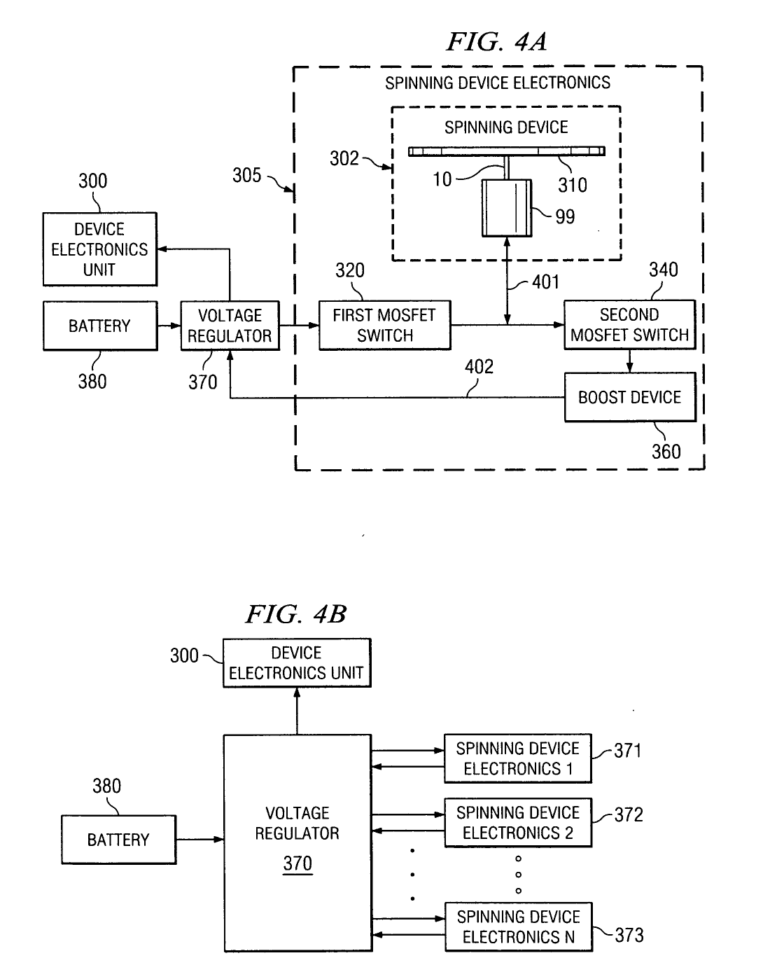

FIG. 4A shows a system that utilizes energy generated by spinning device electronics 305. Spinning device 302 couples to a first MOSFET switch 320 and a second MOSFET switch 340. First MOSFET switch 320 also couples to voltage regulator 370 and second MOSFET switch 340. Second MOSFET switch 340 connects to a boost device 360. In some embodiments of the invention, first MOSFET switch 320 and second MOSFET switch 340 may couple to device electronics unit 300 and are controlled by device electronics unit 300. Boost device 360 further couples to voltage regulator 370. Voltage regulator 370 couples to battery 380 and device electronics unit 300. Spinning device 302 may comprise motor unit 99, rotor 10, and disk 310 as described above. Spinning device 302, battery 380, voltage regulator 370, and device electronics unit 300 may be similar to the components of the same name described above in reference to FIG. 2.

Battery 380 powers device electronics unit 300 when first MOSFET switch 320 is in the open state. This ensures that the spinning device 302 is not needlessly powered. Current flows from battery 380 to motor unit 99 of spinning device 302 when first MOSFET switch 320 is in the closed state and second MOSFET switch 340 is in the open state. Battery 380 may power device electronics unit 300 and spinning device 302 at the same time. When motor unit 99 needs to spin disk 310, current flows from battery 380 through voltage regulator 370 and first MOSFET switch 320 that is in the closed state to motor unit 99. In some embodiments of the invention, if second MOSFET switch 340 is in the open state, no current flows to boost device 360.

When battery 380 powers motor unit 99, motor unit 99 spins rotor 10 and disk 310 so that data may be read from disk 310. When battery 380 stops powering motor unit 99, motor unit 99 may produce a back EMF voltage and a current, as described above, as motor unit 99 slows to a stop. The voltage generated by slowing motor unit 99 may be mathematically represented by Faraday's law:

$${V}_{EMF} = - N \frac{ⅆ Φ}{ⅆ t} \qquad Formula 1$$

In Formula 1, V_{EMF} is an electromotive force (EMF) voltage, N is the number of turns in a coil of wire, and φ is magnetic flux. Magnetic flux φ is proportional to the lines of a magnetic field that surround a magnet multiplied by the perpendicular area that the magnetic field penetrates. Magnetic flux may be changing over time because the perpendicular area that the magnetic field penetrates may be changing. Thus, Formula 1 shows that when a changing magnetic flux φ interacts with a coil of wire having N turns, a V_{EMF} is produced equal to the rate of change of the magnetic flux multiplied by the number of turns multiplied by negative 1.

Thus, as shown in FIG. 1, as each tooth that is a magnet with north or south polarity in rotor 10 rotates, the corresponding magnetic field associated with the tooth also rotates. The rotating magnetic field of each tooth passes over each winding so that a voltage, as given by Formula 1, is created across each winding.

Motor unit 99 may generate a DC voltage by controlling the V_{EMF} generation process using a control circuit. Such a control circuit, not shown in the figures, may couple to the windings of motor unit 99. The control circuit may continually reverse the direction of the current generated across the windings so that a DC voltage is produced. In some other embodiments of the invention, motor unit 99 may generate an AC voltage and an AC to DC converter may convert the alternating current to direct current. Thus, spinning device 302 may output a DC voltage.

The windings of motor unit 99 may couple together in parallel or series fashion and may further be coupled to first MOSFET switch 320 and second MOSFET switch 340 through connection 401. When spinning device 302 functions as a generator, first MOSFET switch 320 may be in the open state and second MOSFET switch 340 may in the closed state, thus allowing current to flow from motor unit 99 through second MOSFET switch 340 to boost device 360.

Boost device 360, which may also be referred to as a boost converter or charge pump, receives the current generated by spinning device 302 and boosts the voltage to a higher, regulated voltage using one or more capacitors. The boosted voltage may be at a level suitable to power device electronics unit 300. Boost device 360 may be, for example, a Texas Instruments TPS60100 High Power, Low Noise Charge Pump or an alternative type of boost device, boost converter, or charge pump. Current may pass from boost device 360 to voltage regulator 370 through connection 402. Voltage regulator 370 ensures that the output voltage to device electronic unit 300 is relatively noise free, smooth, and at a constant level. Spinning device 302 may then power device electronics unit 300 as long as spinning device 302 generates current. When spinning device 302 no longer generates current, battery 380 may resume powering device electronics unit 300.

Spinning device 302 may not provide a significant amount of current to device electronics unit 300 each time spinning device 302 generates current. However, the cumulative effect of the current generated when spinning device 302 is turned off may decrease the demand on battery 380. This may consequently lengthen the time that a portable device using such a system may operate.

In accordance with some other embodiments of FIG. 4A, boost device 360 may be coupled directly to device electronics unit 300 and voltage regulator 370 may be contained in boost device 360. A second voltage regulator may be in battery 380 that connects to device electronics unit 300 and first MOSFET switch 320. Also, first MOSFET switch 320 and second MOSFET switch 340 may be any devices capable of opening and closing a circuit. Further, as described above, an AC to DC converter may be coupled, if necessary, between spinning device 302 and boost device 360 (not shown in FIG. 4A). In some other embodiments of the invention, battery 380 may be any device such as an electrical outlet or an uninterruptible power supply that provides power to the system shown in FIG. 4A. The system show in FIG. 4A may be implemented for an external media device such as an external CD-RW drive, external hard drive, or external DVD writer that may be coupled to a computer.

In some embodiments of the invention, spinning device electronics 300 may include spinning device 302, first MOSFET switch 320, second MOSFET switch 340, and boost device 360. FIG. 4B shows spinning device electronics 1 371, spinning device electronics 2 372, . . . spinning device electronics N 373 coupled to voltage regulator 370. Current flows from battery 380 through voltage regulator 370 to spinning device electronics. When one of the spinning device electronics 371, 372, . . . 373 generates current, the current flows to voltage regulator 370 and further to device electronics unit 300.

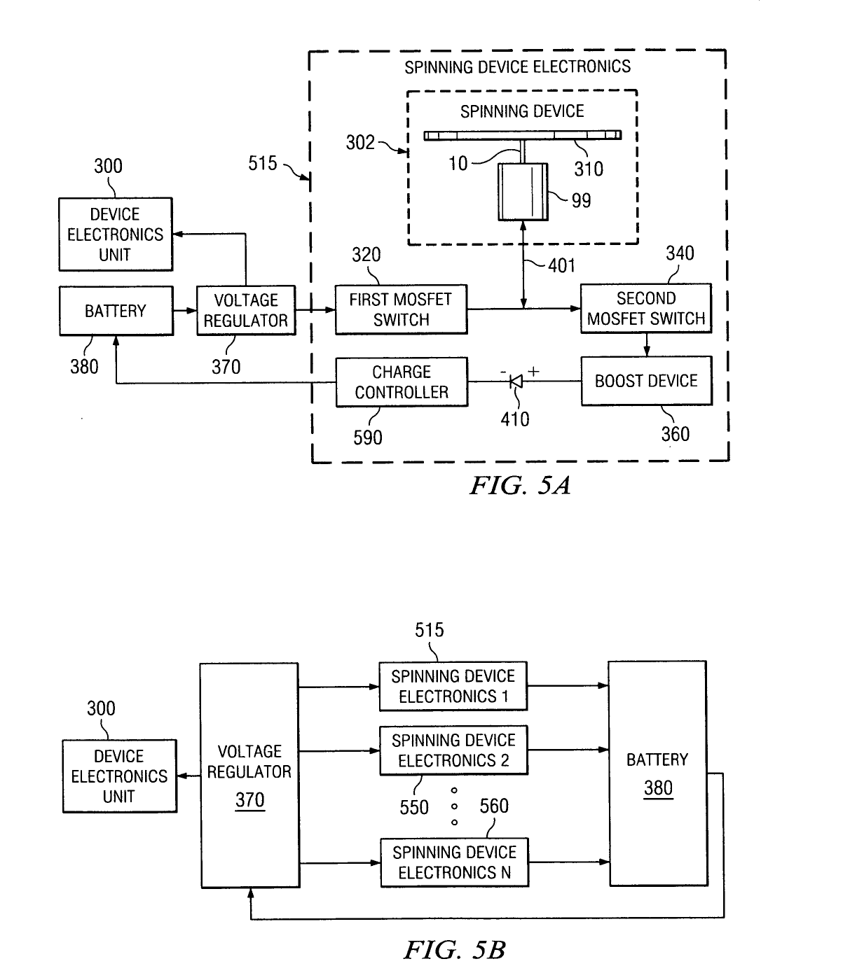

FIG. 5A, in accordance with some embodiments of the invention, shows a system in which current generated by spinning device 302 passes through boost device 360 to charge battery 380. In accordance with some embodiments of the invention, aspects of the system shown in FIG. 5A may be similar to the system shown in FIG. 4A. Spinning device 302 couples to first MOSFET switch 320 and second MOSFET switch 340. First MOSFET switch 320 and second MOSFET switch 340 may be coupled to device electronics unit 300 (not shown in FIG. 5A) and controlled by device electronics unit 300. First MOSFET switch 320 also couples to voltage regulator 370 and second MOSFET switch 340. Second MOSFET switch 340 connects to boost device 360. Boost device 360 further couples to battery 380. Voltage regulator 370 couples to battery 380 and device electronics unit 300. Spinning device 302 may comprise motor unit 99, rotor 10, and disk 310 as described above. Spinning device 302, battery 380, voltage regulator 370, and device electronics unit 300 may be similar to the components of the same name described above in reference to FIG. 4A.

First MOSFET switch 320 may be in the open state when battery 380 powers device electronics unit 300. This ensures that battery 380 does not power spinning device 302. Current flows to motor unit 99 when first MOSFET switch 320 is in the closed state and second MOSFET switch 340 is in the open state. In some embodiments of the invention, spinning device 302 may be a hard disk drive. In such a system, when a hard disk drive read occurs, current flows from battery 380 through voltage regulator 370 and first MOSFET switch 320 that is in the closed state to motor unit 99. No current may be sent to boost device 360 because second MOSFET switch 340 is in the open state. When motor unit 99 is powered, motor unit 99 may spin rotor 10 and disk 310 so that data may be read from the hard drive disk. When the motor unit 99 is no longer powered, motor unit 99 slows and produces a back EMF voltage and a current as described above.

The windings, across which a back EMF voltage and a current may be generated, may couple to first MOSFET switch 320 and second MOSFET switch 340 through connection 401. The windings may be coupled together in a serial or parallel fashion. When current is generated by spinning device 302, first MOSFET switch 320 is placed in the open state and second MOSFET switch 340 is placed in the closed state so that current may flow from motor unit 99 through second MOSFET switch 340 to boost device 360. Boost device 360, which may also be referred to as a boost converter or charge pump, may receive the current from spinning device 350 and boost the voltage to a higher, regulated voltage using one or more capacitors. The voltage is boosted to a level suitable to charge battery 380. Current flows from boost device 360 through diode 410 to charge battery 380.

The anode (+) of diode 410 couples to boost device 360, and the cathode (−) of diode 410 couples to battery 380. If the voltage at boost device 360 is greater than the voltage of battery 380 plus the voltage drop across diode 410, current from boost device 360 charges battery 380. Diode 410 serves to ensure that current only flows from boost device 360 to battery 380 and not from battery 380 to boost device 360.

In some embodiments of the invention as shown in FIG. 5A, battery 380 may be constantly powering device electronics unit 300. Battery 380 may be charged whenever spinning device 302 generates current. The cumulative effect of the current generated by spinning device 302 when motor unit 99 is turned off may decrease the demand on battery 380. Thus, the length of time that a device using such a system may operate independent of an outside power source may be increased.

In accordance with some other embodiments of FIG. 5A, current may flow through boost device 360 to battery 380 as well as device electronics unit 300. Also, first MOSFET switch 320 and second MOSFET switch 340 may be any devices capable of opening and closing a circuit. In some embodiments of the invention, voltage regulator 370 may be in battery 380. Further, in some embodiments of the invention, diode 410 may be in boost device 360 or battery 380. The system shown in FIG. 5A may be in an external media device, such as an external hard drive or an external CD or DVD writer that is coupled to a computer.

In accordance with some embodiments of the invention, a charge controller 590 may couple between cathode (−) of diode 410 and battery 380. Charge controller 590 may optimize the charging of battery 380. For example, when current flows from boost device 360 through diode 410 to charge controller 590, charge controller 590 may regulate the amount of current sent to battery 380 in order to optimize the charging of battery 380. Charge controller 590 may also prevent boost device 360 from overcharging battery 380.

In some embodiments of the invention, spinning device electronics 515 may include spinning device 302, first MOSFET switch 320, second MOSFET switch 340, boost device 360, and diode 410. FIG. 5B shows spinning device electronics 1 515, spinning device electronics 2 550, . . . spinning device electronics N 560 coupled to voltage regulator 370 and battery 380. Device electronics unit 300 and battery 380 also connect to voltage regulator 370. Current flows from battery 380 to a spinning device electronics. When one of the spinning device electronics generates current, the current flows to charge battery 380.

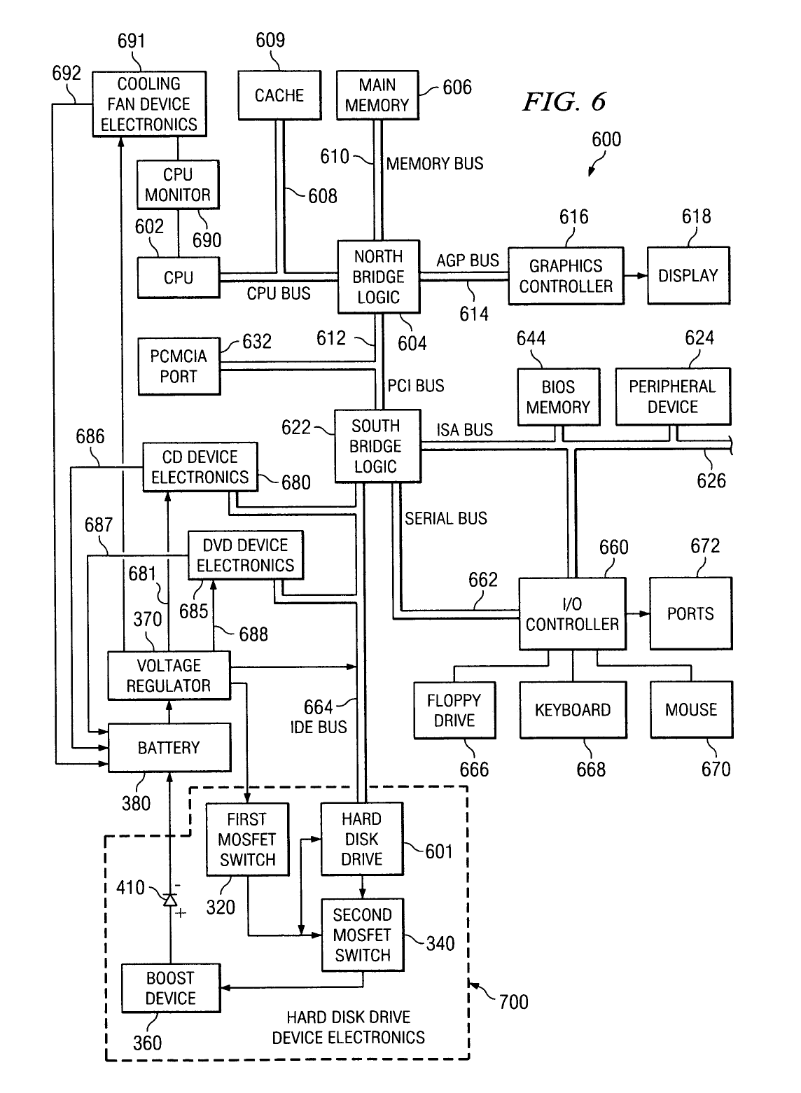

Turning now to FIG. 6, in accordance with some embodiments of the invention, a hard disk drive device electronics 700 similar to spinning device electronics 515 is coupled to a portable computer system 600. Device electronics unit 300 may include the electronics of portable computer system 600. Computer system 600 generally includes a central processing unit (CPU) 602 coupled to a main memory array 606 and to a variety of other peripheral computer system components through an integrated bridge logic device 604. Bridge logic device 604 is sometimes referred to as a “North bridge” for no other reason than it often is depicted at the upper end of a computer system drawing. CPU 602 couples to North bridge logic 604 via a CPU bus 608, or bridge logic 604 may be integrated into CPU 602. CPU 602 may comprise, for example, a Pentium™ IV processor. It should be understood, however, that computer system 600 could include other alternative types of processors. Further, an embodiment of computer system 600 may include a multiprocessor architecture, with each processor coupled to North bridge logic unit 604. An external cache memory unit 609 further may couple to CPU bus 608 or through a separate bus (not shown) to CPU 602. A CPU monitor 690 couples to CPU 602. CPU monitor 690 monitors the temperature and activity of CPU 602 and controls cooling fan device electronics 691. Cooling fan device electronics 691 spins a fan (not shown) to keep CPU 602 cool during operation. Cooling fan device electronics 691 may be a spinning device electronics 515 shown in FIG. 5A. When current is no longer supplied to cooling fan device electronics 691, cooling fan device electronics 691 generates current that may be used to charge battery 380 through connection 692.

Main memory array 606 couples to bridge logic unit 604 through a memory bus 610. Main memory array 606 includes a conventional memory device or array of memory devices in which program instructions and data are stored. Main memory array 606 may comprise any suitable type of memory such as dynamic random access memory (DRAM) or any of the various types of DRAM devices such as synchronous DRAM (SDRAM), extended data output DRAM (EDO DRAM), or Rambus™ DRAM (RDRAM).

North bridge logic 604 couples CPU 602 and memory 606 to peripheral devices in the system through a Peripheral Component Interconnect (PCI) bus 612 or other expansion bus, such as an Extended Industry Standard Architecture (EISA) bus. The embodiments of the invention, however, are not limited to any particular type of expansion bus, and thus various buses may be used, including a high speed (66 MHz or faster) PCI bus. Various peripheral devices that implement the PCI protocol may reside on the PCI bus 612.

Computer system 600 includes a graphics controller 616 that couples to bridge logic 604 via an expansion bus 614. As shown in FIG. 6, expansion bus 614 comprises an Advanced Graphics Port (AGP) bus. Alternatively, graphics controller 616 may couple to bridge logic 604 through PCI bus 612 (not shown in FIG. 6). Graphics controller 616 may embody a typical graphics accelerator that renders three-dimensional structures on display 618.

North bridge logic 604 includes an interface for initiating and receiving cycles to and from components on AGP bus 614. Display 618 may be any suitable electronic display device upon which an image or text can be represented. A suitable display device may include, for example, a cathode ray tube (CRT), a liquid crystal display (LCD), a thin film transistor (TFT), a virtual retinal display (VRD), or any other type of display device for a computer system.

Computer system 600 optionally may include a Personal Computer Memory Card International Association (PCMCIA) port 632 coupled to the PCI bus 612. The PCMCIA port 632 is accessible from the outside of the computer and accepts one or more expansion cards that are housed in special PCMCIA enclosures that are approximately the size of credit cards but slightly thicker. Accordingly, PCMCIA ports are particularly useful in laptop computer systems, in which space is at a premium. A PCMCIA card typically includes one connector that attaches to PCMCIA port 632, and additional connectors in the PCMCIA card may be included for attaching cables or other devices to the card. Various types of PCMCIA cards are available, including modem cards, network interface cards, bus controller cards, and memory expansion cards.

If other secondary expansion buses are provided in the computer system, another bridge logic device typically couples the PCI bus 612 to that expansion bus. This bridge logic is sometimes referred to as a “South bridge,” reflecting its location in relation to the North bridge in a typical computer system drawing. In FIG. 6, South bridge 622 couples PCI bus 612 to an Industry Standard Architecture (ISA) bus 626 and to an Integrated Drive Electronics (IDE) bus 664. IDE bus 664 typically interfaces input and output devices such as a CD ROM drive, a DVD drive, a hard disk drive (HDD), and one or more floppy disk drives. IDE bus 664 shown in FIG. 6 couples to a hard disk drive 601.

HDD 601 may be a spinning device 302 as shown in FIG. 5A. HDD 601 couples to first MOSFET switch 320 and second MOSFET switch 340. First MOSFET switch 320 couples to voltage regulator 370 and second MOSFET switch 340. Second MOSFET switch 340 also couples to boost device 360. Boost device 360 further couples to battery 380 through diode 410. Battery 380 may be coupled to the power line of IDE Bus 664 (not shown in FIG. 6) through voltage regulator 370. In some embodiments of the invention, HDD 601 consists of motor unit 99, rotor 10, and disk 310 (not shown), and may be similar to spinning device 302 described above in reference to FIG. 5A. Battery 380, voltage regulator 370, and boost device 360 are described above with reference to FIGS. 4A and 5A.

After a hard drive read or write occurs in HDD 601, the spinning medium in HDD 601 spinning device 302 generates a back EMF voltage after current no longer flows to motor unit 99. Boost device 360 boosts the back EMF voltage generated HDD 601. The current from boost device 360 charges battery 380. Battery 380 provides power to the components shown in FIG. 6 such as CPU 602, main memory 606, graphics controller 616, etc. Battery 380 may be coupled to other components of portable computer system 600 through connections not shown in FIG. 6. If, for example, a second hard disk drive is also coupled to the IDE bus 664, power generated from the second hard disk drive may also be used to charge battery 380.

A CD device electronics 680 and a DVD device electronics 685 also couple to IDE bus 664. Both devices may be spinning device electronics as shown in FIG. 5A. Battery 380 provides power to CD device electronics 680 through voltage regulator 370 and connection 681. Battery 380 also provides power to DVD device electronics 685 through voltage regulator 370 and connection 688. When the battery stops providing power to CD device electronics 680 or DVD device electronics 685, these devices may generate current to charge battery 380 through connection 686 and 687, respectively.

Various ISA-compatible devices are shown coupled to the ISA bus 626, including a BIOS memory 644 and a peripheral device 624. BIOS memory 644 is a memory device that stores commands which instruct the computer to perform basic functions such as sending video data to the display or accessing data on floppy disk drives. In addition, BIOS memory 644 may be used to store power management instructions for hardware-based (or “legacy”) power management systems or to store register definitions for software-based power management systems. The BIOS instructions also enable the processor to load the operating system software program into main memory during system initialization and begin execution of the operating system software program. BIOS memory 644 typically is a “nonvolatile” memory device. In a “nonvolatile” memory device, memory contents remain intact even when computer 600 powers down. By contrast, the contents of main memory 606 typically are “volatile” and thus are lost when the computer shuts down.

In some embodiments of the invention, south bridge 622 couples to an input/output (I/O) controller 660 that further couples to input/output devices such as keyboard 668, mouse 670, floppy disk drive 666, general purpose parallel and serial ports 672, and various input switches such as a power switch and a sleep switch (not shown). I/O controller 660 may couple to South bridge 622 through ISA bus 626. A serial bus 662 may provide an additional connection between I/O controller 660 and South bridge 622. I/O controller 660 may include an ISA bus interface (not shown) and transmit and receive registers (not shown) for exchanging data with South bridge 622 over serial bus 662.

As described above, in accordance with some embodiments of the invention, the implementations shown in FIGS. 4A, 4B, 5A, 5B, and 6 may be powered by the current generated by spinning device 302. This current may power device electronics unit 300 or charge battery 380. Thus, the implementations described above utilize back EMF voltages generated by spinning devices within a portable electronic device so that the battery life in the portable electronic device may be extended.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method of powering an electronic device, comprising:
stopping power transferring to a motor in a spinning device in the electronic device;
generating a voltage across at least one winding of the motor and boosting said voltage; and
powering the electronic device with the boosted voltage.

2. The method of claim 1, wherein the spinning device is a hard disk drive, digital video disk (DVD) device, compact disk (CD) device, tape system, or cooling fan.

3. The method of claim 1, comprising converting the voltage generated across the at least one winding to a direct current voltage.

4. A method of charging a battery, comprising:
stopping power transferring to a motor in a spinning device in an electronic device;
generating a voltage across at least one winding of the motor and boosting said voltage; and
charging the battery with the boosted voltage.

5. The method of claim 4, wherein the battery powers the electronic device.

6. The method of claim 4, comprising converting the voltage generated across the at least one winding to a direct current voltage, wherein the spinning device in the electronic device is a hard disk drive, digital video disk (DVD) device, compact disk (CD) device, tape system, or cooling fan.

7. An apparatus to power an electronic device, comprising:
at least one spinning device capable of producing a voltage;
a boost device coupled to the at least one spinning device; and
a device electronics unit coupled to the boost device.

8. The apparatus of claim 7, comprising a power source coupled to the at least one spinning device.

9. The apparatus of claim 8, wherein the power source is a battery, an electrical outlet, or an uninterruptible power supply.

10. The apparatus of claim 8, comprising a voltage regulator coupled to the at least one spinning device, wherein the power source couples to the at least one spinning device through said voltage regulator.

11. The apparatus of claim 10, wherein the device electronics unit couples to the boost device through the voltage regulator.

12. The apparatus of claim 11, comprising:
a first switch coupled to the spinning device, wherein the voltage regulator couples to the spinning device through the first switch; and
a second switch coupled to the spinning device and the first switch, wherein the spinning device and the first switch couple to the boost device through the second switch.

13. The apparatus of claim 12, wherein the first switch is a MOSFET switch, and the second switch is a MOSFET switch.

14. The apparatus of claim 12, wherein if the first switch is closed, current is capable of flowing from the power source to the spinning device, and if the second switch is closed, current is capable of flowing from the spinning device to the boost device and further to the device electronics unit.

15. The apparatus of claim 7, wherein the spinning device is a hard disk drive, DVD device, CD device, tape system, or cooling fan.

16. The apparatus of claim 7, wherein the device electronics unit further comprises:
a north bridge;
a processor coupled to the north bridge;
a memory device coupled to the north bridge;
a cache coupled to the north bridge;
a graphics controller coupled to the north bridge;
a display coupled to the graphics controller; and
a PCMCIA power coupled to the north bridge.

17. The apparatus of claim 7, wherein the device electronics unit further comprises:
a south bridge;
a peripheral device coupled to the south bridge;
a CD device coupled to the south bridge;
a DVD device coupled to the south bridge;
a hard disk drive coupled to the south bridge;
an I/O controller coupled to the south bridge; and
a floppy disk drive coupled to the I/O controller.

18. The apparatus of claim 7, wherein the at least one spinning device further comprises a motor, said motor further comprising:
a frame;
a shaft attached to the frame;
a rotor attached to the shaft, wherein said rotor is capable of rotating at a variable spin rate; and
a rotating medium attached to the rotor, wherein said rotor is capable of spinning said rotating medium.

19. The apparatus of claim 18, wherein the rotating medium is a disk.

20. The apparatus of claim 18, wherein the motor is a spindle motor, a stepper motor, a brushless DC motor, a servomotor, or a variable reluctance motor.

21. The apparatus of claim 18, wherein said motor further comprises:
a plurality of poles attached to the frame;
windings attached to each of the plurality of poles; and
wherein the rotor is capable of generating the voltage across at least one of the windings proportional to the spin rate of said rotor.

22. The apparatus of claim 21, wherein the windings are coupled to the boost device

23. An apparatus to charge at least one battery in an electronic device, comprising:
at least one spinning device capable of producing a voltage;
a battery coupled to the at least one spinning device;
a boost device coupled to the at least one spinning device unit, wherein said boost device further couples to the battery; and
a device electronics unit coupled to the battery.

24. The apparatus of claim 23, wherein the spinning device is a hard disk drive, DVD device, CD device, tape system, or cooling fan.

25. The apparatus of claim 23, comprising a voltage regulator coupled to the at least one spinning device, wherein the battery couples to said at least one spinning device through said voltage regulator.

26. The apparatus of claim 25, wherein the device electronics unit couples to the boost device through the voltage regulator.

27. The apparatus of claim 26, comprising:
a first switch coupled to the spinning device, wherein the voltage regulator couples to the spinning device through the first switch; and
a second switch coupled to the spinning device and the first switch, wherein the spinning device and the first switch couple to the boost device through the second switch.

28. The apparatus of claim 27, wherein the first switch is a MOSFET switch, and the second switch is a MOSFET switch.

29. The apparatus of claim 27, wherein if the first switch is closed, current is capable of flowing from the battery to the spinning device, and if the second switch is closed, current is capable of flowing from the spinning device to the boost device and further to the battery, wherein the current is capable of charging the battery.

30. The apparatus of claim 23, wherein the at least one spinning device further comprises a motor, said motor further comprising:
a frame;
a shaft attached to the frame;
a rotor attached to the shaft, wherein said rotor is capable of rotating at a variable spin rate; and
a rotating medium attached to the rotor, wherein said rotor of said motor is capable of spinning said rotating medium.

31. The apparatus of claim 30, wherein said motor further comprises:
a plurality of poles attached to the frame;
windings attached to each of the plurality of poles; and
wherein the rotor is capable of generating the voltage across at least one of the windings proportional to the spin rate of said rotor.

32. The apparatus of claim 31, wherein the windings are coupled to the boost device.

33. The apparatus of claim 23, comprising a diode coupled to the boost device, wherein said boost device couples to the battery through the diode.

34. The apparatus of claim 33, wherein the diode further comprises:
a cathode, wherein the cathode couples to the battery;
an anode coupled to the cathode, wherein the anode couples to the boost device; and
wherein the battery is charged if a voltage at the boost device is greater than a voltage drop at the diode plus a voltage of the battery.

35. The apparatus of claim 33, comprising a charge controller coupled between the battery and the diode, said charge controller capable of regulating the charging of said battery.
